(19) United States
(12) Patent Application Publication
(10) Pub. No.: US 2010/0145514 A1
(43) Pub. Date: Jun. 10, 2010

(54) APPARATUS AND METHOD FOR CONTROLLING MULTI-ROBOT LINKED IN VIRTUAL SPACE

(75) Inventors: Hyun KIM, Daejeon-city (KR); Kangwoo Lee, Daejeon-city (KR); Youngho Suh, Gwangju (KR); Joonmyun Cho, Daejeon-city (KR); Myungeun Kim, Daejeon-city (KR); Taegun Kang, Daejeon-city (KR); Janarbek Matai, Daejeon-city (KR); Hyoungsun Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/630,175

(22) Filed: Dec. 3, 2009

(30) Foreign Application Priority Data
Dec. 8, 2008 (KR) 10-2008-0124120

(51) Int. Cl. G05B 19/418

(52) U.S. Cl. 700/248

(57) ABSTRACT

The present invention relates to an apparatus and method for controlling a multi-robot linked in virtual space, and when an event is generated in accordance with information change in virtual space including the web as well as the environmental change around a robot, the present invention controls individual behavior or collective behavior or corresponding robots by transmitting behavior data corresponding to the generated event to a plurality of robots. According to the present invention, by making a robot perform specific behavior in response to not only changes in the real environment, but information changes in the web, it is possible to arouse the user's interest or the developer's originality while removing due to complicity of the real environment, which is a problem limiting application of the robot, or dynamic response.

### RELATED APPLICATIONS

The present application claims priority to Korean Patent Application Serial Number 10-2008-0124120, filed on Dec. 8, 2008, the entirety of which is hereby incorporated by reference.

### BACKGROUND OF THE INVENTION

1. Field of the Invention

The present invention relates to an apparatus and a method for controlling a multi-robot linked in virtual space, particularly an apparatus and a method for controlling a multi-robot linked in virtual space which performs specific behavior in response to not only changes in the environment around the robot, but information changes in virtual space, such as the web.

2. Description of the Related Art

Recently, many researches have been conducted to utilize robots in the real life. In these researches, robots were generally manufactured to take the shape of a human being or in the shapes of objects existing in real life, such as a puppy, to increase affection for the users. Further, robots manufactured as described above have been developed to perform similar behavior to a human being or animals by interacting with the users in the real life.

For example, there have been many researches on using an insect's behavior as models for robots, after a robot imitating an ant was proposed and experiments for the robot were conducted by ‘Deneubourg’ et al. in the early 1990's. Further, robots imitating pets, such as ‘Sony Aibo’ or ‘Omron’, or imitating mammals, such as ‘Paro’, had been developed by Japan, as leader, and used in real life. ‘Wowwee Robosapien’ was developed as a toy that is moved by remote control, imitating simple behavior of a human being or dinosaurs.

However, those robots had limited functions in arousing continuous interest of the users, because the robots had behavior patterns that could be expected from real organisms by the users or they performed specific behavior only, when the users applied physical input, in response to the input. Accordingly, it is required to develop a robot that can continuously arouse the users' interest.

### SUMMARY OF THE INVENTION

It is an object of the present invention to provide an apparatus and a method for controlling a multi-robot linked in virtual space that make robots various behaviors which the user cannot expect, by making the robots respond information changes not only in the real environment, but virtual space including the web.

Further, it is another object of the present invention to provide an apparatus and a method for controlling a multi-robot linked in virtual space that actuates robots to perform various behaviors by separating the hardware and the software of each robot and binding different application software to hardware robots.

Further, it is another object of the present invention to provide an apparatus and a method for controlling a multi-robot linked in virtual space that implement more various behaviors that utilizing a robot, which is a single object, by making a society of robot groups and implementing specific collective behavior for specific conditions.

Further, it is another object of the present invention to make a user have more curiosity and interest in a robot and continuously observe the robot, by providing the robot with behavior patterns different from real organisms such that the user cannot easily guess the function and basic behavior principle from the robot's behavior.

In order to accomplish the objects, an apparatus for controlling a multi-robot linked in virtual space according to the present invention is an apparatus for controlling a multi-robot linked in virtual space, which includes a control robot controlling behavior of a plurality of robots in accordance with information changes in the virtual space, in which the control robot includes: an event processor, when changed information is received from the gateway server for virtual space that is linked with the virtual space and collects information in the virtual space, manages an event corresponding to the changed information; and a robot task that reads the event of the event processor and transmits behavior data corresponding to the event of behavior data stored in a storage unit to a corresponding robot.

The control robot sets one or more information categories in the gateway server for virtual space, and receives an information change event from the gateway server for virtual space, when information change is generated in the set information categories.

The robot task transmits behavior data corresponding to the event to a plurality of robots, or transmits behavior data corresponding to the event to each group including the plurality of robots, when the event by the information change in the virtual space satisfies a predetermined condition.

The behavior data includes behavior information corresponding to the function of each of the robots, and a control command for implementing corresponding behavior, in which the behavior data includes different control commands in accordance with the function of each robot pertaining to the predetermined groups and includes different control commands in accordance with environmental information around each robot pertaining to the predetermined group.

The control robot further includes an task coordinator that classifies the plurality of robots into one or more groups and allocates work to the robots included in each group, in which the task coordinator downloads the robot task from a robot management server where the plurality of robots are registered, and binds the robot task to each robot or each group.

The robot task, when an event in accordance with a change in environmental information around the robot is generated, transmits behavior data corresponding to the event in accordance with the change in environmental information to a corresponding robot, on the basis of environmental information detected by the plurality of robots.

Further, the control robot further includes a robot monitoring unit that manages the condition of each robot on the basis of environmental information detected by the plurality of robots.

Further, in order to accomplish the objects, a method of controlling a multi-robot linked in virtual space is a method of controlling a robot using information of virtual space of a control robot controlling behavior of a plurality of robots in accordance with information changes in the virtual space, which includes: receiving changed information from gateway server for virtual space that is linked with the virtual space and collects information in the virtual space; detecting an event corresponding to the received information; and transmitting behavior data corresponding to an event in accordance with information change in the virtual space to a corresponding robot.

The method further includes setting one or more information categories in the gateway server for virtual space, and the changed information is included in the set information categories.

The behavior data includes behavior information corresponding to the function of each of the robots, and a control command for implementing corresponding behavior. Further, the behavior data includes different control command in accordance with the function of each robot pertaining to the predetermined groups, and includes different control commands in accordance with environmental information around each robot pertaining to the predetermined group.

The method further includes: classifying the plurality of robots into one or more groups; and monitoring behavior of a corresponding robot in the classified groups.

Further, the method of controlling a robot according to the present invention further includes:

confirming whether environmental information around the robots is changed, by receiving environmental information detected by the plurality of robots; and

when the environmental information around the robots is changed, generating an event corresponding to the changed environmental information.

Further, the transmitting of behavior data transmits the behavior data to a corresponding robot or the group including a corresponding robot, when the environmental information around the robots is changed.

Further, the method of controlling a robot further includes downloading a predetermined number of robot tasks from a robot management server where a plurality of robot tasks is registered; and binding the downloaded applications to at least one of the plurality of robots.

According to the present invention, by making a robot perform specific behavior in response to not only changes in the real environment, but information changes in the web, it is possible to arouse the user's interest or the developer's originality while removing due to complicity of the real environment, which is a problem limiting application of the robot, or dynamic response.

Further, a robot performs various behaviors by separating the hardware device and the application software of a robot and binding different application software to hardware the robot. Accordingly, it is possible to prevent the robot from performing a dull behavior pattern and implementing a robot having various behaviors patterns.

Further, by binding one application software to a plurality of robots such that a plurality of robots perform collective behavior, it is possible to arouse continuous interest of a user.

### BRIEF DESCRIPTION OF THE DRAWINGS

FIG. 1 is a diagram illustrating the configuration of a system where an apparatus for controlling a robot according to the present invention is applied;

FIGS. 2 and 3 are block diagrams that are referred to illustrate the configuration of the apparatus for controlling a robot according to the present invention;

FIGS. 4 and 5 are diagrams that are referred to illustrate the operation of the apparatus for controlling a robot according to the present invention; and

FIGS. 6 to 7B are flowcharts illustrating the operation flow of a method of controlling a robot according to the present invention.

### DETAILED DESCRIPTION OF THE PREFERRED EMBODIMENTS

Hereinafter, embodiments of the present invention will be described with reference to the accompanying drawings.

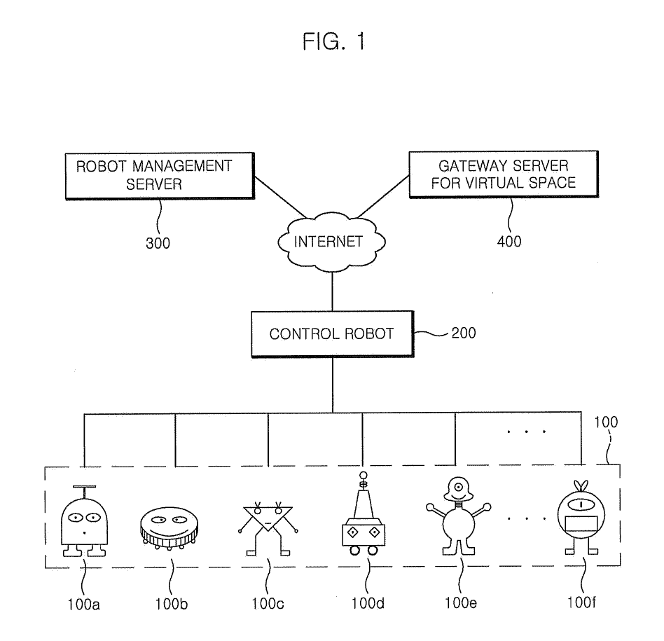

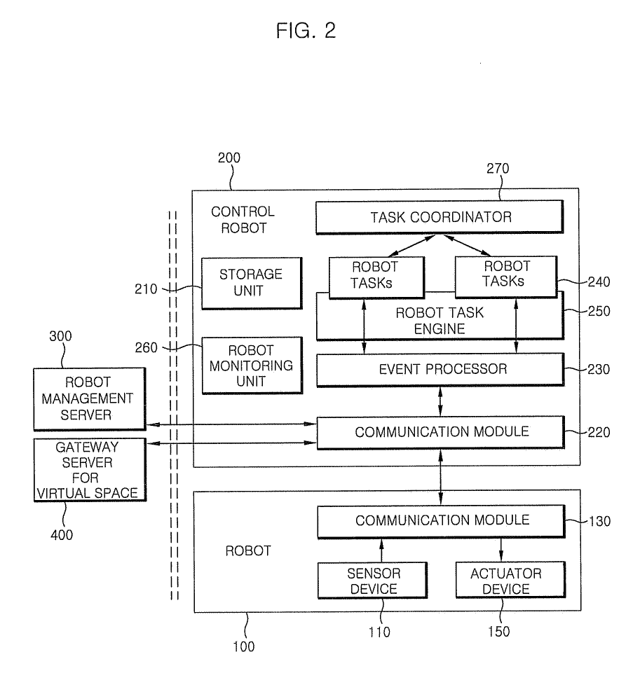

FIG. 1 and FIG. 2 are diagrams referred to illustrate the configuration of an apparatus for controlling a multi-robot linked in virtual space according to the present invention.

First, FIG. 1 illustrates the entire system configuration of the apparatus for controlling a multi-robot linked in virtual space according to an embodiment of the present invention. Referring to FIG. 1, a robot control system that the present invention proposes includes a plurality of robots 100 and a control robot 200 that separately or simultaneously controls the robots 100. The plurality of robots 100 function as children and the control robot 200 function as a motor of the plurality of robots 100, thereby establishing a society.

That is, the plurality of robots 100, the children, performs specific behavior in response to the real environment or performs specific behavior according to changes in certain information of virtual space including the web. In this configuration, the plurality of robots 100 do not have the shapes of organisms that can be easily seen in the real life, such as a human being, animals, and insects, but are implemented in shapes that do not really exist. Therefore, the users' curiosity for the robots 100 is stimulated.

The virtual space may be the virtual space of the internet herein, and may be a virtual computing environment formed in a computer. As described above, the virtual space is not limited to any one.

The control robot 200 is a robot that functions as a mother of the plurality of robots 100. That is, the control robot 200 detects environmental changes around the plurality of robots 100 or environmental changes in the virtual space, determines behavior for the plurality of robots 100 and instructs the behavior to the corresponding robots 100, and observes the behavior of each of the robots 100. The control robot 200 can also be implemented in various shapes and may be implemented to have the same shape of the robots 100.

A robot control system according to the present invention includes gateway server for virtual space 400 that collects information in the virtual space.

The gateway server for virtual space 400 includes a proxy gateway (not shown) for obtaining information from the existing various information systems, such as web application, internet-based information providing systems, and an event processor (not shown) for transmitting the information to the control robot 200.

The gateway server for virtual space 400 detects changes in certain information in the virtual space by connecting with a information providing means including the web through the proxy gateway, and provides the corresponding information to the control robot 200 according to the changes of the information. Accordingly, the control robot 200 instructs corresponding behavior to each of the robots 100 in accordance with the information changes in the virtual space provided from the gateway server for virtual space 400.

Further, the robot control system according to the present invention further includes a robot management server 300 that manages information on the plurality of robots 100 and application software for controlling the plurality of robots 100.

The robot management server 300 stores hardware functions, behavior information, and robot task software for each of the plurality of robots 100. That is, the robots 100 are developed with separate hardware and software, in which the developer of the hardware of the robots 100 should describe the hardware functions and behavior information of the corresponding robots in a standardized way and then register them to the robot management server 300, after developing the hardware of the robots.

Similarly, the developer of the software of the robots 100 should register the application software, which he/she has developed, and functions and behavior of the robots 100 that are required to execute the corresponding application software.

The information registered in the robot management server 300 is utilized by the control robot 200, when each of the robots 100 is practically installed and utilized. That is, the control robot 200 downloads the application software registered in the robot management server 300 and then dinamically binds the application software with the plurality of robots 100 connected to the control robot 200. As a result, the control robot 200 actuates the corresponding robots 100 by executing the application software.

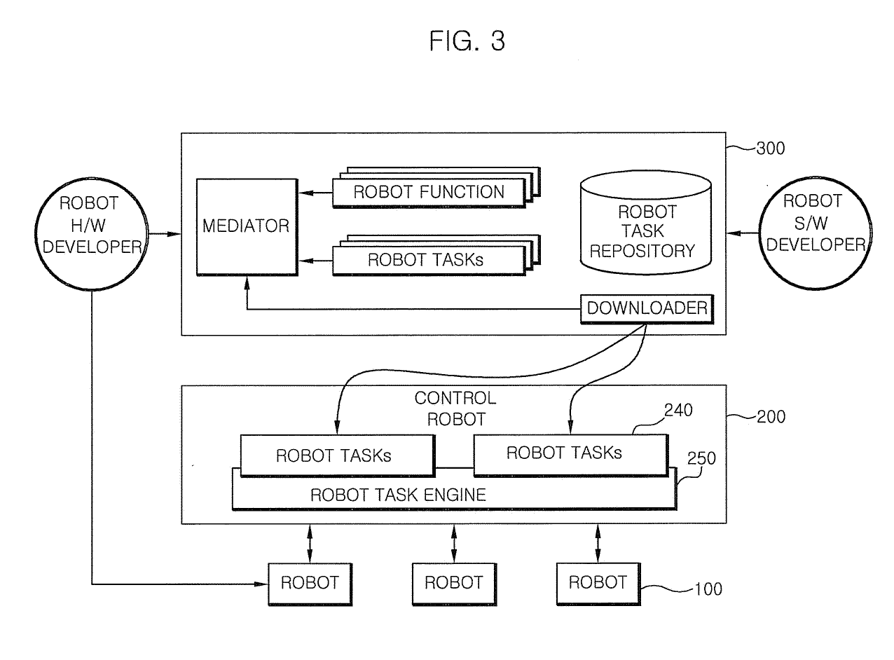

The configuration of the apparatus for controlling a robot using information in virtual space according to the present invention is described in detail with reference to FIG. 2 and FIG. 3.

FIG. 2 and FIG. 3 are block diagrams that are referred to illustrate an apparatus for controlling a robot using information in virtual space and the system configuration.

First, the robot 100 includes a sensor device 110 provided with a plurality of sensors, a communication module 130 for communication with the control robot 200, and an actuator device 150 that controls the robot 100 to be actuated.

The sensor device 110 is provided with a plurality of sensors for detecting enviromental information around the robot 100, and a light detecting sensor, a microphone, and a motion detecting sensor etc. may be used for the sensors. The sensor device 110 detects the environmental information around the robot 100 in real time while the robot 100 is actuated. The information detected by the sensor device 110 is transmitted to the control robot 200 through the communication module 130.

The communication module 130 supports a communication interface of a wire/wireless communication type for transmitting/receiving data to/from the control robot 200. The communication module 130 transmits the information detected by the sensor device 110 to the control robot 200, and receives the behavior data transmitted from the control robot 200 and then transmits the behavior data to the actuator device 150.

The actuator device 150 is provided with actuators, such as a wheel, a speaker, an LED, and a display etc. Accordingly, when behavior data of the control robot 200 is received through the communication robot 130, the actuator device 150 activates a corresponding actuator in accordance with the control command included in the behavior data such that the robot 100 performs the corresponding operation.

The control robot 200 includes a storage unit 210, a communication module 220, an event processor 230, robot tasks 240, a robot task engine 250, a robot monitoring unit 260, and an task coordinator 270.

The storage unit 210 stores application software downloaded from the robot management server 300 and the function of each robot 100. Further, the storage unit 210 stores behavior information corresponding to the function of each robot 100. The behavior data includes the behavior information corresponding to the function of each robot 100 and a control command for implementing corresponding behavior.

The communication module 220 supports a communication interface of a wire/wireless communication type for transmitting/receiving data to/from the robot 100. The communication module 220 receives the environmental information detected by the sensor device 110 of the robot 110. Further, the communication module 220 transmits behavior data including a control command given from the control robot 200 to the robot 100. In this configuration, the communication module 220 for transmitting/receiving data to/from the robot 100 is provided with a near field communication type module, such as an infrared light communication module and Bluetooth, etc. Meanwhile, the communication module 220 is connected to the robot management server 300 or the gateway server for virtual space 400 and transmits/receives data.

The event processor 230 manages the environmental information, respectively received from the plurality of robots 100 through the communication module, in an event type. The event processor 230 receives, processes, and transmits all events generated by information change from the sensors of the robots 100 and information change of the virtual space.

The robot task 240 is a means that processes the events of the event processor 230. In response to an event generated from environmental information of the robot 100, the robot task 240 determines what behavior the corresponding robot 100 should perform and transmits the corresponding behavior data to the corresponding robot 100 through the communication module 220.

The robot task 240 is defined by ‘Finite State Machine’ and ‘ECA (Event-Condition-Action) Rule’ herein. Further, the process of the robot task 240 is executed by the robot task engine 250.

For example, when light is turned on around the artificial organism robot 100, which is a synthetic organism, the sensor device 110 of the robot 100 transmits information detected from the light (strength and direction, etc. of the light) to the control robot. The robot task 240 measures the strength of the light from the event of the event processor 230, and when the strength is larger than a predetermined value, transmits behavior data moving in the direction of the light to the corresponding robot 100. Therefore, the robots 100 receiving behavior data from the control robot 200 all move in the direction of the light, thereby performing behavior gathering around the light.

Further, for another example, by a purity detecting sensor, when the purity inside the actual space drops below a reference level, the sensor device 110 of the robot 100 detects it and transmits an event to the control robot 200. Meanwhile, the robot task 240 of the control robot 200 transmits behavior data to the robot 100 in response to the detected event. Accordingly, the robot 100 starts to clean according to the behavior data transmitted from the control robot 200.

As described above, the control robot 200 performs various behaviors according to the environmental information detected by the robot 100, such that the user's interest is aroused and it can be possible to increase availability of the robot 100.

In the robot control system, not only changes in the environmental information around the plurality of robots 100, but changes in the virtual space are monitored. In this operation, the gateway server for virtual space 400 can be implemented as a virtual machine that is driven by the control robot 200.

That is, when an information change is detected by updating new information on the web, the event processor 230 outputs an event to inform it. Further, the event processor 230 of the control robot 200 manages the event outputted from the gateway server for virtual space 400. Accordingly, the robot task 240 transmits behavior data corresponding to the event of the event processor 230 to a corresponding robot or all the robots.

For example, when news of death due to a terror is updated on the internet, the gateway server for virtual space 400 confirms the news and outputs an event. The communication module 210 of the control robot 200 receives the event and transmits it to the event processor 230. The robot task 240 transmits behavior data corresponding to sorrow from the event, which has been transmitted to the event processor 230, to each robot 100. Accordingly, the robots 100 are aligned and perform sorrowful behavior, such as flickering or paying silent tribute, depending on the function of each robot 100.

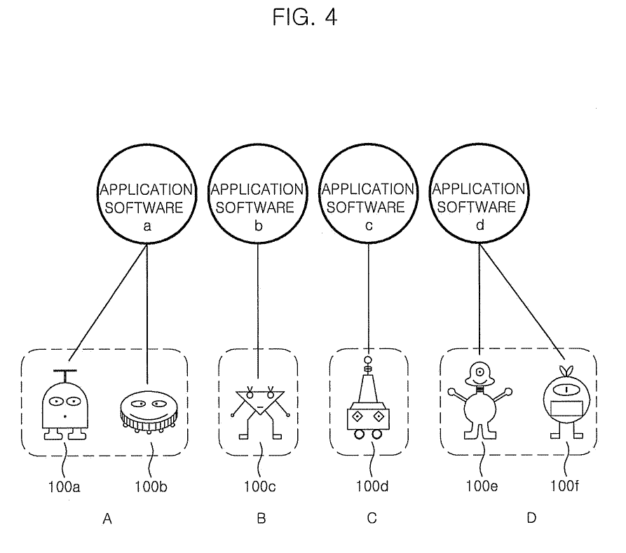

On the other hand, the task coordinator 270 processes team formation of the plurality of robots 100 and task allocation to the robots pertaining to each group, or each robot. Further, the task coordinator 270 manages collaborative control and conflict resolution between the robots pertaining to the groups, which is described in detail with reference to the embodiment shown in FIG. 4.

The robot monitoring unit 260 monitors the condition of each robot 100 on the basis of the environmental information received from the plurality of robots 100. The robot monitoring unit 260 enables the user to recognize the condition of each robot by outputting the condition of each robot 100 through the display or the LED.

Further, the robot monitoring unit 260 monitors errors etc. generated in the robot 100. If a problem occurs in the sensor module etc. of the robot 100, the robot monitoring unit 260 informs the robot task 240 bound to the corresponding robot of the fact. Accordingly, the corresponding robot task 240 removes the problem by resetting the sensor module of the corresponding robot. Meanwhile, the robot monitoring unit 260 may inform the user of the problem by outputting the problem generated in the corresponding robot.

Further, the control robot 200 according to the present invention includes a charger (not shown) for supplying operational electric power to the plurality of robots 100.

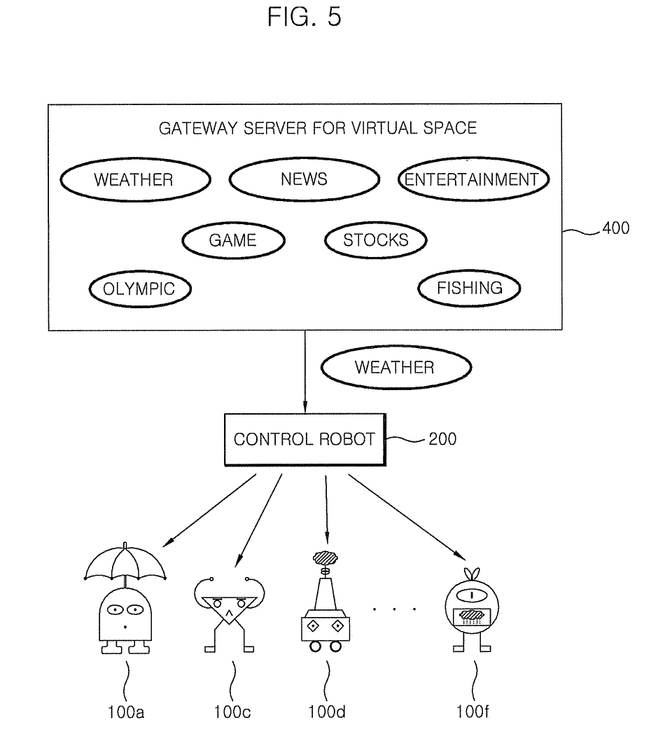

FIG. 4 and FIG. 5 are diagrams that are referred to illustrate the operation of the apparatus for controlling a robot of the present invention. First, FIG. 4 is a diagram illustrating an exemplary embodiment of when a predetermined number of groups are formed, as hardware and application software are separated in the apparatus for controlling a robot according to the present invention.

The task coordinator 270 of the control robot 200 forms predetermined groups for the plurality of robots 100 and binds the robot tasks 240 to each group. In this operation, the robot task 240 controls the robots in the bound groups such that the operations allocated by the task coordinator 270 are performed. Accordingly, the robots 100 pertaining to the same group can perform group behavior by the robot task 240. The group behavior herein can be implemented by combination of individual behavior of each robot and may be implemented by collective behavior of all of the robots.

That is, the task coordinator 270 of the control robot 200, as shown in FIG. 4, classifies the plurality of robots 100a, 100b, 100c, 100d, 100e, 100f into A, B, C, and D groups of {100a, 100b}, {100c, 100d}, and {100e, 100f}. The control robot 200 makes the groups perform different behavior. In other words, the control robot 200 performs behavior ‘a’ by application software ‘a’ in the group A, and performs behavior ‘b’ by application software ‘b’ in the group B.

Further, the control robot 200 implements behavior ‘c’ by application software ‘c’ in the group C and finally performs behavior ‘d’ by application software ‘d’ in the group D. In this operation, the same behavior data is received in the robots pertaining to each group, such that they can perform behavior corresponding to the data. Although behavior data is data for the same behavior, it can include different commands, depending on the function of each robot pertaining to the corresponding group or the environment, such as the position of each robot.

For example, when behavior data about a victory ceremony is transmitted to each robot, the behavior transmitted to each robot may include a control command about the behavior of turning at one position, a control command of jumping at one position, a control command of flickering the LED, or a control command of dancing to the left and right, in accordance with the function of each robot.

Further, when behavior data of gathering to the detected light is transmitted to each robot, the behavior data transmitted to each robot may include a control command of moving at different distances in different directions, in accordance with the position of the corresponding robots.

Accordingly, the control robot 200 can achieve an integrated group of robots or independent robots 100, in accordance with the rules of the robot task 240 controlling the robots 100.

On the other hand, when conflict occurs between the robots in each group, the task coordinator 270 of the control robot 200 removes the conflict generated between the corresponding robots and then controls the behavior through the robot tasks 240 bound to the corresponding robots.

For example, when conflict occurs between robots or control commands, such as when robots that are moving collides with each other or a control command is received from the robot task 240 to a robot that is performing a specific behavior, the task coordinator 270 performs a process of removing the conflict, such as transmitting new behavior data by adjusting the movement command to remove the conflict, or holding a control command of another application in the event processor.

FIG. 5 shows an embodiment of when the behavior of the robot is controlled according to information changes in virtual space according to the present invention.

Categories that are observed for information changes, such as weather, news, entertainment, game, stocks, and sports etc., are registered in the gateway server for virtual space 400. The gateway server for virtual space 400 monitors information changes in the registered categories, when information change is detected, informs the control robot 200 of the information change. In this operation, the gateway server for virtual space 400 informs in an event type.

As shown in FIG. 5, the categories registered in the gateway server for virtual space 400 are weather, news, entertainment, game, stocks, olympics, and fishing, the gateway server for virtual space 400 monitors whether new information is updated in the registered categories. If weather forecast saying it will rain is updated in the weather category, an event including changed weather information, such as weather and precipitation is provided to the control robot 200.

In this operation, the robot task 240 of the control robot 200 transmits behavior data, which corresponds to the weather change event of the event processor 230, to each robot 100.

Each robot 100 receiving behavior data corresponding to the weather forecast reciting it will rain from the control robot 200 actuates the actuator in accordance with the control command included in the behavior data received to correspond to the function of corresponding robot 100. In other words, the robot 100a performs behavior of opening an umbrella in accordance with the behavior data corresponding to the weather forecast reciting it will rain. The robot 100c performs the behavior of covering the face with its hands in accordance with the behavior data corresponding to the weather forecast reciting it will rain.

Meanwhile, the robot 100d performs behavior expressing a character of dark clouds outside in accordance with the behavior data corresponding to the weather forecast saying it will rain. Further, the robot 100f may output an rainy image through the display in accordance with the behavior data corresponding to the weather forecast saying it will rain. Alternatively, each robot may perform behavior that the user cannot expect, such as turning in a circle. The user's interest is aroused by making the robots perform unexpected behavior.

The operation of the present invention having the above configuration is as follows.

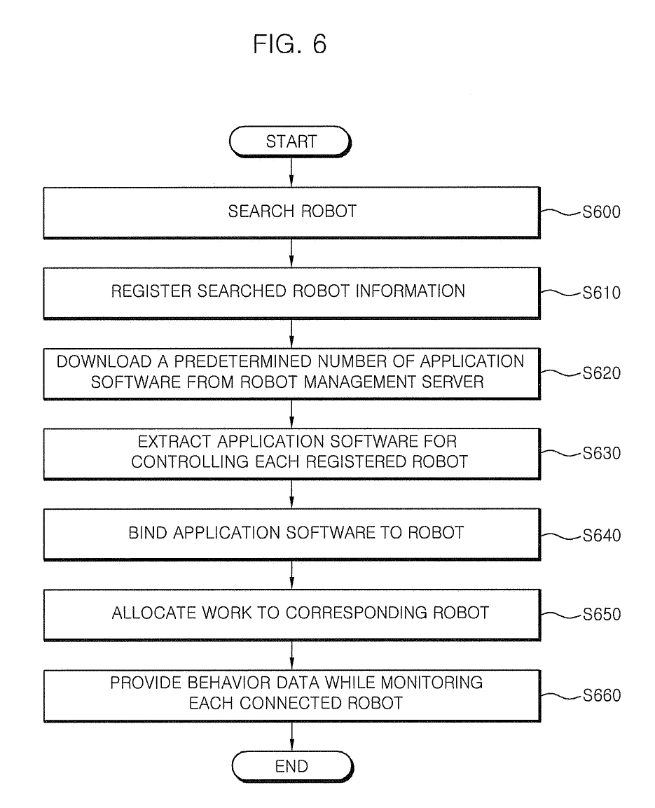

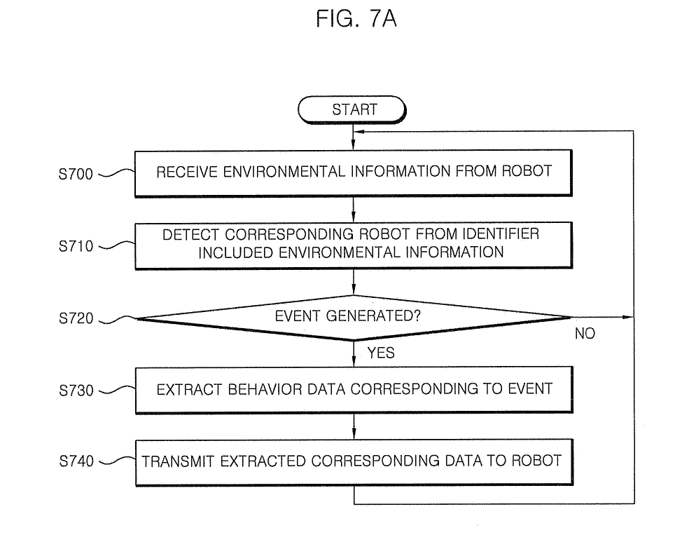

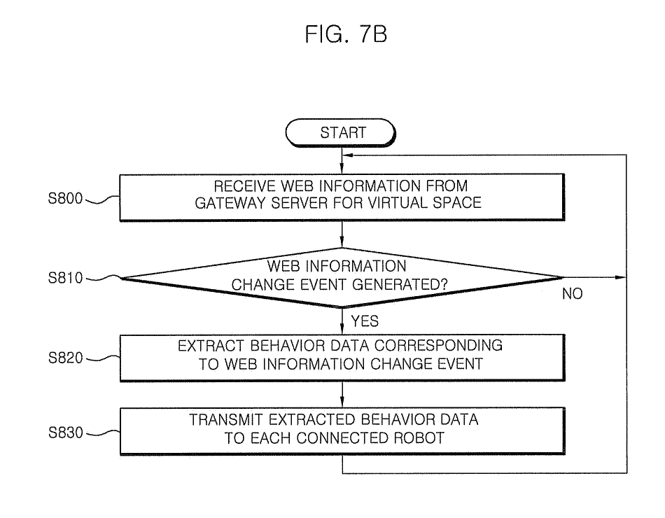

FIG. 6 to FIG. 7B are flowcharts illustrating the operational process of a method of controlling a robot using information of virtual space according to the present invention.

First, FIG. 6 is a flowchart illustrating the operational process of a method of generally controlling a plurality of robots in an apparatus for controlling a robot according to the present invention. Referring to FIG. 6, the control robot 200 searches a robot 100 positioned within a predetermined region (S600). The control robot 200 registers information on the robot 100 searched in the predetermined region to the robot management server 300 (S610).

Meanwhile, the control robot 200 downloads at least one or more robot task 240 from the robot management server 300 (S620). In this process, step ‘S620’ may be performed before step ‘S600’.

The task coordinator 270 of the control robot 200 extracts application software, that is, the robot task 240, for controlling each robot (S630), and binds it to a predetermined robot 100 (S640). The task coordinator 270 can bind the robot task 240 to each robot 100, and can also bind the robot task 240 to each group by forming predetermined groups of robots.

Accordingly, the task coordinator 270 allocates work to each robot or group (S650) and each robot task 240 monitors the bound robot 100 in real time and provides behavior data to the corresponding robot 100 (S650).

FIG. 7A is a flowchart illustrating the operational process of a method of controlling a robot to perform the corresponding behavior in accordance with the environmental changes around the robot in an apparatus for controlling a robot according to the present invention.

Referring to FIG. 7A, the plurality of robots 100 is connected to a control robot 200 by wireless or wire communication, and detects environmental information, using a plurality of sensor modules, and transmits the information to the control robot 200 in real time.

Meanwhile, when receiving the environmental information from the plurality of robots 100 (S700), the control robot 200 monitors information around the corresponding robot 100 on the basis of the signal received from the corresponding robot 100. The control robot 200 confirms the corresponding robot 100 from the identifier included in the information received from each robot 100 (S710) and monitors information around the identified robot 100.

If a specific event is generated while monitoring information around a specific robot 100 (S720), the robot task 240 of the control robot 200 extracts behavior information corresponding to the generated event (S730) and transmits the extracted behavior information and behavior data including a control command corresponding to the information to the corresponding robot (S740). Further, even if different events are generated from different robots or the same robot, the robot task 240 repeats steps ‘S700’ to ‘S740’, thereby controlling the behavior of each robot 100.

FIG. 7B is a flowchart illustrating the operational process of a method of controlling behavior of a robot in accordance with information changes in virtual space in an apparatus for controlling a robot according to the present invention.

Referring to FIG. 7B, the gateway server for virtual space 400 monitors information in the virtual space in real time and transmits changed web information to the control robot 200.

The control robot 200 receives web information from the gateway server for virtual space 400 (S800), the robot task 240 generates a web information change event on the basis of the received information (S810). In this operation, the robot task 240 transmits behavior data corresponding to the web information change event to each robot (S820, S830). The behavior data can be simultaneously transmitted to all robots, or may be transmitted only to a predetermined number of robots or a predetermined groups of robots.

Steps ‘S800’ to ‘S830’ are repeated every time web information is received from the gateway server for virtual space 400.

As described above, an apparatus and a method for a multi-robot linked in virtual space according to the present invention is not limited to the configuration and the methods of the embodiments described above, and all or a portion of each embodiment may be selectively combined such that the embodiments can be modified in various ways.

What is claimed is:

1. An apparatus for controlling a multi-robot linked in virtual space including a control robot controlling behavior of a plurality of robots in accordance with information changes in virtual space, wherein the control robot includes:
an event processor, when changed information is received from the gateway server for virtual space that is linked with the virtual space and collects information in the virtual space, manages an event corresponding to the changed information; and
a robot task that reads the event of the event processor and transmits behavior data corresponding to the event of behavior data stored in a storage unit to a corresponding robot.

2. The apparatus for controlling a multi-robot linked in virtual space according to claim 1, wherein the control robot sets one or more information categories in the gateway server for virtual space, and receives an information change event from the gateway server for virtual space, when information change is generated in the set information categories.

3. The apparatus for controlling a multi-robot linked in virtual space according to claim 1, wherein the robot task transmits behavior data corresponding to the event to a plurality of robots, when the event by the information change in the virtual space satisfies a predetermined condition.

4. The apparatus for controlling a multi-robot linked in virtual space according to claim 1, wherein the robot task transmits behavior data corresponding to the event to each group including the plurality of robots, when the event by information change in the virtual space satisfies a predetermined condition.

5. The apparatus for controlling a multi-robot linked in virtual space according to claim 1, wherein the behavior data includes behavior information corresponding to the function of each of the robots, and a control command for implementing corresponding behavior.

6. The apparatus for controlling a multi-robot linked in virtual space according to claim 5, wherein the behavior data includes different control commands in accordance with the function of each robot pertaining to the predetermined groups.

7. The apparatus for controlling a multi-robot linked in virtual space according to claim 5, wherein the behavior data includes different control commands in accordance with environmental information around each robot pertaining to the predetermined group.

8. The apparatus for controlling a multi-robot linked in virtual space according to claim 1, wherein the control robot further includes an task coordinator that classifies the plurality of robots into one or more groups and allocates work to the robots included in each group.

9. The apparatus for controlling a multi-robot linked in virtual space according to claim 8, wherein the task coordinator downloads the robot task from a robot management server where the plurality of robots are registered, and binds the robot task to each robot or each group.

10. The apparatus for controlling a multi-robot linked in virtual space according to claim 1, wherein the robot task, when an event in accordance with a change in environmental information around the robot is generated, transmits behavior data corresponding to the event in accordance with the change in environmental information to a corresponding robot, on the basis of environmental information detected by the plurality of robots.

11. The apparatus for controlling a multi-robot linked in virtual space according to claim 1, wherein the control robot further includes a robot monitoring unit that manages the condition of each robot on the basis of environmental information detected by the plurality of robots.

12. The method of controlling a multi-robot linked in virtual space of a control robot controlling behavior of a plurality of robots in accordance with information changes in the virtual space, comprising:
receiving changed information from gateway server for virtual space that is linked with the virtual space and collects information in the virtual space;
detecting an event corresponding to the received information; and
transmitting behavior data corresponding to an event in accordance with information change in the virtual space to a corresponding robot.

13. The method of controlling a multi-robot linked in virtual space according to claim 12, further comprising:
setting one or more information categories in the gateway server for virtual space, and
the changed information is included in the set information categories.

14. The method of controlling a multi-robot linked in virtual space according to claim 12, wherein the behavior data includes behavior information corresponding to the function of each of the robots, and a control command for implementing corresponding behavior.

15. The method of controlling a multi-robot linked in virtual space according to claim 14, wherein the behavior data includes different control command in accordance with the function of each robot pertaining to the predetermined groups.

16. The method of controlling a multi-robot linked in virtual space according to claim 14, wherein the behavior data includes different control commands in accordance with environmental information around each robot pertaining to the predetermined group.

17. The method of controlling a multi-robot linked in virtual space according to claim 12, further comprising:
classifying the plurality of robots into one or more groups; and
monitoring the behavior of a corresponding robot in the classified groups.

18. The method of controlling a multi-robot linked in virtual space according to claim 12, further comprising:
confirming whether environmental information around the robots is changed, by receiving environmental information detected by the plurality of robots; and
when the environmental information around the robots is changed, generating an event corresponding to the changed environmental information.

19. The method of controlling a multi-robot linked in virtual space according to claim 12, wherein the transmitting of behavior data transmits the behavior data to a corresponding robot or the group including a corresponding robot, when the environmental information around the robots is changed.

20. The method of controlling a multi-robot linked in virtual space according to claim 12, further comprising:
downloading a predetermined number of robot tasks from a robot management server where a plurality of robot tasks is registered; and
binding the downloaded robot tasks to at least one of the plurality of robots.
